(19) United States
(12) Patent Application Publication
(10) Pub. No.: US 2026/0220723 A1
(43) Pub. Date: Jul. 30, 2026

(54) Predictive Modeling for identifying potential buyers for identified real estate properties

(71) Applicants: Stas Miroslavov Kostadinov, Monroe, NC (US); Joshua Ryan Chan, Monroe, NC (US)

(72) Inventors: Stas Miroslavov Kostadinov, Monroe, NC (US); Joshua Ryan Chan, Monroe, NC (US)

(21) Appl. No.: 19/037,133

(22) Filed: Jan. 25, 2025

(51) Int. Cl. G06Q 50/163; G06Q 30/0204

(52) U.S. Cl. CPC G06Q 50/163

(57) ABSTRACT

A method for identifying potential buyers for a real estate property includes several steps. Initially, the method begins by receiving an address or APN of the real estate property from a user. The method then retrieves property characteristics associated with the received address from a database and identifies similar properties based on the property characteristics associated with the received address. Following this, the method identifies buyers among real estate investors who have historically purchased identified similar properties and analyzes their behavior patterns. Buyers are then categorized into one of three groups including fix and flip, buy and hold and Builders/Developers. The method then searches for the potential buyers from the groups within a first predefined area. Thereafter, the method compiles a list of the potential buyers for the real estate property and displays the list to the user.

### FIELD OF THE INVENTION

The present invention relates generally to real estate property transactions. More specifically, the present invention involves a method for identifying potential buyers for real estate properties and eliminating the need for third-party involvement and associated commission fees.

### BACKGROUND OF THE INVENTION

Real estate property transactions are undergoing tremendous transition owing to technological improvements and changing market conditions. Identifying potential buyers in the ever-evolving real estate industry is critical for optimizing property sales and ensuring successful deals. Traditional methods for identifying buyers generally rely on personal networks and real estate agents. However, these traditional methods are not efficient as these methods do not accurately target the most interested buyers and additionally, some commission is required to be paid. To address these shortcomings, the present invention provides a method that uses historical and public data to identify potential buyers for identified real estate properties.

### SUMMARY OF THE INVENTION

This section is provided to introduce objects and aspects of the subject matter. This section is not an extensive overview of the subject matter, and is not intended to identify the key features of the embodiments or to delineate the scope of the claimed subject matter.

A first aspect of the present inventions relates to a method for identifying potential buyers for a real estate property. The method includes receiving an address or Assessor's Parcel Number (APN) of the real estate property from a user. The method further includes retrieving property characteristics associated with the received address and APN from a database. This includes identifying the property type such as whether it is a single-family residence, townhome, duplex, multifamily unit, commercial buildings or land. Additionally, the method identifies property attributes such as presence of a pool, basement, garage, or carport, as well as the number of stories (one or two). It also identifies styles of property such as ranch style, colonial, or bungalow, among others. Other important details include zoning of the property, year the property was built, total property value, number of bedrooms, number of bathrooms, square footage of the property, and land size. The method further includes identifying similar properties based on the property characteristics associated with the received address. The method further includes identifying buyers among real estate investors who have historically purchased similar properties, for example in the area, and analyzing their existing real estate portfolio to determine their preferred buying criteria and behavior patterns. Key factors considered in this analysis are the frequency of property purchases, average purchase prices, preferred property conditions, and annual deal volume. Based on these behavioral patterns, the buyers are categorized into one of three groups including fix and flip, buy and hold, and developers/builders. The method further includes searching for a specified number of potential buyers from the groups within a first predefined area. In an embodiment, the first predefined area includes a radius of at least 0.1 miles around the received property address. In an another embodiment, the radius may be at least 0.5 miles, at least 5 miles, or at least 10 miles. Additionally, in yet another embodiment, the radius may be no more than 15 miles, while another embodiment may limit the radius to no more than 10 miles, and yet another embodiment to no more than 5 miles, and yet another embodiment to no more than 0.5 miles, and yet another embodiment to no more than 0.1 miles. Combinations of these distances may also be utilized. The method further includes compiling a list of the potential buyers for the real estate property, wherein the list includes their potential names, potential email or office addresses, mail address potential social media profile, and potential phone numbers, and displaying the list to the user to enable direct outreach to each of these potential buyers.

In one embodiment the name can be a Unique Name, which is defined herein as to an identifiable name that there are no duplicates, i.e. a single identifiable individual or company in the US.

In one embodiment the mailing address can be a Unique Mailing Address, which is defined herein as a single identifiable address in the US for a specific property, for example: 123 main street, Charlote NC 28277, however, 456 Main Street, Charlotte NC 28277 is not a unique address if there are Suites 1, 2, 3, or 4. unless the address also includes suite No. Unique Mailing Address may be used to track Trusts where Unique Names cannot be tracked however Unique Mailing Address, which is common in purchase of 2 or more properties can provide a lead for that entity as a potential buyer.

In an embodiment, the database includes all the data such as buyer's historical transactions, which consist of properties that the buyer has purchased and sold in the past, as well as current transactions involving properties that the buyer is flipping, developing, or holding at present, buyer profile and property identifier including property characteristics and ownership details.

In an embodiment, the data is stored in the database in steps including collecting data from a plurality of sources such as public records and historical sales data, performing cleaning of the collected data, and converting the cleaned data into a structured format compatible with the database, which involves parsing and standardizing over a plurality of columns of data point. Thereafter, the steps include compiling property identifiers and buyer profiles.

In an embodiment, the buyer profile is compiled in steps including identifying a plurality of buyers with a history of real estate transactions, classifying the identified buyers based on their purchasing behavior and investment strategies. In one embodiment, buyers are found and identified by their Unique Name (first name, middle name/initial, last name) or Unique Company Name or buyer Unique Mailing Address. The identified buyers are classified in one of the categories including buy and hold investors who retain purchased properties over time, fix and flip investors who purchase, renovate, and sell properties within a predetermined timeframe, builders/developers who acquire land or properties for development and sale, commercial property buyers who invest primarily in commercial real estate, and hedge fund/institutional buyers who hold a portfolio of 150 or more properties. The steps further include determining buyer profiles for each category by evaluating historical transaction data including fix & flip transaction history, New builds from the ground up transaction history, cash purchasing history, frequency of property purchases within a specified period, ownership of a real estate portfolio comprising two or more properties not occupied by the buyer, recent addition of at least one new property to their portfolio within the last 12 months, comparing the historical purchase price of properties against their estimated Automated Valuation Model (AVM) values at the time of purchase, for example an AVM value of less than 80% may indicate as an investor purchase. The steps further include assigning characteristics to each buyer profile based on property attributes, including but not limited to Last Sale Price, Buyer favorite location preferences, Year Built, Zoning Code, Property Use, Last Sale Date, Lot Size, Building Area, bedrooms, bathrooms, and Market Valuation. Thereafter, the steps include storing and updating the buyer profiles to enhance the matching accuracy for potential real estate transactions.

In an embodiment, the property identifier is compiled in steps that include extracting data attributes associated with a property, including but not limited to Ownership type (ex: if buyer is individual, trust, or company), length of ownership parcel number, full property address, geographic coordinates, legal description, owner details, ownership and occupancy status, mailing address details, deed information, tax assessment and fiscal details, property construction and zoning information, sales history, building and lot characteristics, room and structural details, environmental and market valuation codes; and storing the extracted data attributes to compile the property identifier.

In an embodiment, the filtering criteria including at least, but not limited to, Buyer preferences based on the current or previous properties they have owned, property details, ownership history, and valuation data are used for identifying the buyers.

In an embodiment, the buyers are scored based on factors similar properties in their current portfolio or previous properties they have purchased, the tracked locations where they prefer to buy or are likely to expand their portfolio, transaction frequency, and cash purchases. This scoring helps identify more experienced and active investors, thereby enhancing the likelihood of a successful deal.

In an embodiment, the potential buyers are searched by matching property characteristics with historical buyer preferences within the predefined area around the received property.

In an embodiment, the method is further configured to update the buyer information every 24 hours, allows the user to connect with the potential buyers quickly and cost-effectively, similar to the Multiple Listing Service (MLS).

In an embodiment, a comparable property is identified within a 0.1-mile radius that has been acquired at a price equal to or less than eighty percent of its current Automated Valuation Model (AVM) value.

In an embodiment, the specified number of potential buyers is identified within an expanded predefined area if the required number of potential buyers is not found in the first predefined area, where the expanded predefined area has a radius greater than 0.1 mile.

### BRIEF DESCRIPTION OF DRAWINGS

The following drawings are illustrative of particular examples of the present disclosure and are not intended to limit the scope of the invention. The drawings are not to scale (unless so stated) and are intended for use in conjunction with the explanations in the following detailed description. Like reference numerals in the following drawings refer to the same parts throughout the different drawings.

FIG. 1 is a flow chart depicting one embodiment of a method of the present invention whereby the method is used for identifying the potential buyers for a real estate property, according to an embodiment of the present invention.

The foregoing shall be more apparent from the following more detailed description of the disclosure.

### DETAILED DESCRIPTION OF THE INVENTION

To be better understood by those skilled in the art, the present invention is described in the following description with reference to the attached drawings.

The ensuing description provides exemplary embodiments only. The embodiments of the present disclosure are provided with specific details to provide a thorough understanding of such embodiments. However, these embodiments may be practiced without the provided specific details. For example, various elements such as electronic units, processes etc may be shown as components in block diagram form in order not to obscure the embodiments in unnecessary detail. Also, the disclosure may be embodied in many different forms and should not be construed as limited to the embodiments set forth herein; rather, these embodiments are provided so that this disclosure will be thorough and complete, and will fully convey its scope to those skilled in the art. It should be understood that the function and arrangement of elements might be changed without departing from the essence and scope of the disclosure as set forth.

The terminology used in the detailed description of the particular exemplary embodiments illustrated in the accompanying drawings is not intended to be limiting. It is pertinent to note that some of the embodiments may be described as a method e.g., in the form of a flow diagram, a flowchart, a structure diagram, a data flow diagram, or a block diagram. In these embodiments the method may be described as a sequential process, however many of the steps can be performed in parallel or concurrently. In a method, the order of the steps may also be re-arranged.

In addition, a figure may indicate that a method is terminated when its steps are completed, however, there may be additional steps that are not included in the figure. Additionally, various features of the present invention can each be used independently of one another or with any combination of other features.

Terms such as “exemplary” indicate an illustration, an instance, or an example, and the disclosed subject matter is not limited by such examples. Furthermore, the detailed description or the claims may contain terms such as “has,” “contains,” and “includes,” etc., however it is important to note that such terms are intended to be inclusive—in a manner similar to an open transition word such as the term “comprising”—without precluding any additional or other elements.

As disclosed in the background section, conventional technologies have many limitations and in order to overcome those limitations of the conventional technologies, the present invention provides a method for identifying potential buyers for a real estate property. and eliminating the need for third-party involvement and associated commission fees.

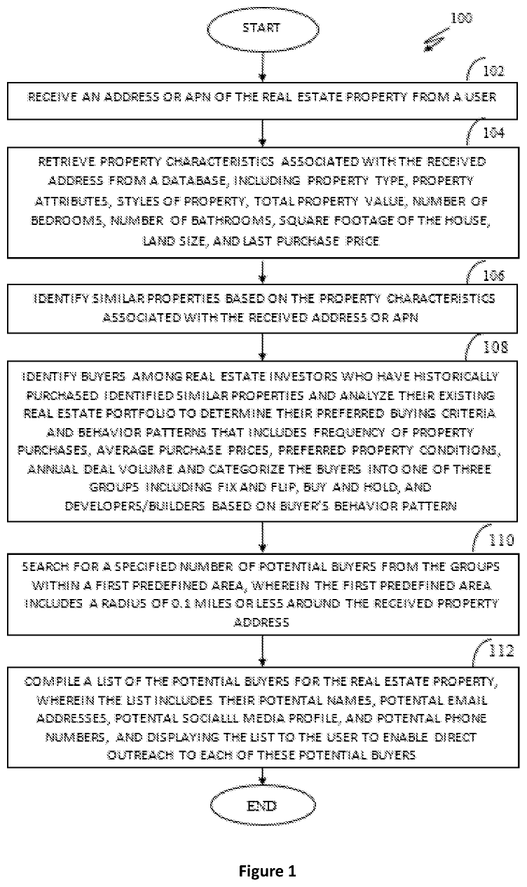

Referring to FIG. 1, a flow chart depicting one embodiment of a method of the present invention whereby the potential buyers are identified for real estate properties or APN, according to an embodiment of the present invention.

In implementation, all steps of the method take place within a real estate transaction platform online. It is important to note that for the method to work, data is required to be collected from a plurality of sources, including public records and historical sales data. Said all steps of identifying the potential buyers to take place in online platform includes data collection, converting into appropriate format, data processing and normalization, using filters for extracting relevant, and using algorithm to know the buyer behavior.

Once the data is collected, it is required to prepare the data to ensure it is suitable for analysis. This includes converting files received from third-party sources through Secure File Transfer Protocol (SFTP) into a standard CSV (Comma-Separated Values) format. This format allows for easier processing and compatibility with database system, such as but not limited to MongoDB or AWS. The dataset comprises over 1,000 columns of information, and the objective is to ensure that all columns are accurately represented and properly formatted for efficient and effective analysis.

After the data is cleaned and formatted, the filters are required to be identified to create an algorithm for data processing. The filters are essential for extracting relevant information from the data and include the following key fields
ParcelNumberRaw: The raw parcel number associated with the property.
PropertyAddressFull: The complete address of the property.
PropertyAddressCity, PropertyAddressState, PropertyAddressZip: These fields specify the city, state, and ZIP code of the property address.
PropertyLatitude, PropertyLongitude: Geographic coordinates of the property.
LegalDescription: The legal description of the property.
PartyOwner1NameFirst, PartyOwner1NameMiddle, PartyOwner1NameLast: The first, middle, and last names of the primary owner.
TrustDescription: Information regarding any trust associated with the property.
CompanyFlag: Indicates whether the owner is a company.
PartyOwner2NameFull: The full name of the second owner, if applicable.
PreviousOwner: The name of the previous owner of the property.
OwnerTypeDescription1: Describes the type of ownership.
ContactOwnerMailAddressFull, ContactOwnerMailAddressCity,
ContactOwnerMailAddressState, ContactOwnerMailAddressZIP: mailing address of the owner.
StatusOwnerOccupiedFlag: Indicates whether the property is owner-occupied or absentee.
DeedOwner1NameFull, DeedOwner2NameFull: Full names of the owners as listed on the deed.
TaxAssessedValueTotal, TaxAssessedValueLand: Total assessed value of the property and the land.
TaxFiscalYear: The fiscal year for tax assessment.
YearBuilt: The year the property was constructed.
ZonedCodeLocal: Local zoning code for the property.
PropertyUseMuni: The municipal use designation of the property.
PropertyUseStandardized: Standardized value to describe property use. Derived from jurisdiction-specific zoned use value obtained from the Assessor.
AssessorLastSaleDate, AssessorLastSaleAmount: Date and amount of the last sale as assessed.
AreaBuilding: Total area in square feet of all structures on the property, including common areas.
AreaLotAcres, AreaLotSF, AreaLotDepth, AreaLotWidth: Various measurements related to the lot size.
PropertyStyle: refers to the architectural design or aesthetic of a building or structure.
RoomsBasementAreaFinished: Finished area in the basement.
ParkingGarage, ParkingGarageArea, ParkingCarport: Information about parking facilities.
Foundation: Type of foundation of the property.
BathCount, RoomsCount, StoriesCount, UnitsCount: Counts of bathrooms, rooms, stories, and units in the property.
Fireplace, Pool: Indicates the presence of a fireplace or pool.
TopographyCode: Code representing the topography of the property.
EstimatedCurrentMarketValue: The current market value is estimated through an Automated Valuation Model (AVM).
EstimatedMinValue, EstimatedMaxValue: Minimum and maximum estimated values based on the AVM.
NumberOfPropertiesCurrentlyOwned: Current number of real properties owned within the real estate investor's portfolio.
PreviousAmountOfPropertiesOwned: Number of real properties that real estate investor has held longer than 12 months previously but is not holding now.
NumberOfPropertiesCurrentlyFlipping: Number of real properties that real estate investor has purchased at a discount and is likely to resell in less than 12 months.
NumberOfPropertiesFlipped: Number of real properties that real estate investor has purchased and resold within a less than 12 month time frame but is not holding now.
NumberOfPropertiesCurrentlyDeveloping: Number of lands that an investor is holding currently with the plans to put improvements on it based off historical data of developer buying land to put improvements on it.
NumberOfPropertiesDeveloped: Number of properties that a real estate developer has built from the ground up.
NumberOfPropertiesOwnedByMailAddress: Used to track how many properties were purchased under the same unique mail address.
NumberOfPropertiesOwnedByPartyOwner1NameFull: Number of properties that were purchased under the same unique Owner 1 full name.
NumberOfPropertiesOwnedByPartyOwner2NameFull: Number of properties that were purchased under the same unique owner 2 full name.
BuyerSalesPriceComparedToAVM: Percent number that buyer acquires property profile on average compared to the AVM of property to help predict if buyer will under pay, pay full value, or over pay for a deal.
NumberOfLandsOwned: Number of land property type that buyer owns.
NumberOfResidentialsOwned: Number of Residential property types that buyer owns.
NumberOfCommercialsOwned: Number of commercial property types that buyer owns.
BuyerTag: All real estate investing categories that buyer is involved in.
AverageBuyerNextPurchaseDuration: Average time frame that buyer is likely to buy next deal based off of historical time frame distance of previously purchased deals.

Further, a structured logic is created that segments the buyers into various categories based on their purchasing behavior and investment strategies. These categories include Buy and Hold, Fix and Flip, Builders/Developers, Commercial Property Buyers, and Hedge, Fund/Institutional Buyers. This segmentation helps in performing marketing and sales strategies effectively.

It is important to note that the buy-and-hold investors are individuals or entities or trusts that purchase properties with the intention of holding them long-term for rental income or appreciation. They are identified by their history of acquiring properties without selling them shortly after purchase.

The Fix and Flip Investors consist of buyers who purchase any type of property, improve them, and sell them for a profit within a short timeframe (typically within 12 months). These investors may be identified by tracking properties that have been bought and subsequently sold at a higher price within this period.

The Builders/Developers are involved in purchasing land and constructing new properties. Their activity is monitored based on the number of land purchases and properties built and sold within a fiscal year.

The Commercial Property Buyers, this category includes investors focused on acquiring commercial real estate, which may involve different metrics and strategies compared to residential properties.

The Hedge Fund/Institutional Buyers are large-scale investors who typically own a significant number of properties (150 or more) and are tracked based on their acquisition patterns and portfolio growth.

To effectively categorize buyers into specific categories, several key factors are required to be analyzed to determine buyer's preferences and investment patterns. These key factors include at least a track record, purchase price analysis, and analyzing buyer dates, and frequency of buying deals. Analyzing buyer's previous and current fix-and flips, new builds, and buy-and-hold's portfolio to profile what is the buyers buying criteria.

In an embodiment, the track record provides a history of individuals, companies, and trusts in adding properties to their real estate portfolios. This includes:
Purchasing properties for cash,
Previous Fix and Flips,
Previous Buy-and-holds,
Previous Developments Completed,
Tracking historical prices buyers have paid for similar properties,
Tracking what and where a buyer is likely to buy based off previous purchases.
Acquiring two or more properties within the last two years or maintaining a portfolio of two or more properties that are not owner-occupied, with at least one new property added in the last 12 months,
Tracking buyer's cash on hand to buy more properties based off liquidated properties,
Tracking if buyers active or inactive based off number of recent transactions,
Tracking historical dollar amount spent at any one time to buy properties,
Tracking quantity patterns to track if buyer is likely to buy large portfolios in 1 purchase,
Tracking historical to track if buyer changed their investment style overtime,
Tracking historical properties that buyer has listed for rent to track buy-and-hold buyers, and/or
Tracking historical Net Worth of buyer's portfolio to see if it has increased or decreased.

The purchase price analysis: This involves comparing the purchase price of properties with their Automated Valuation Model (AVM) estimates. If a property is purchased at some percentage which is 95% or below its market value, for example 80% or below its market value, it provides an indication that it can be classified as an investor purchase. Buyers who retain such properties can be categorized as Buy and Hold investors.
Data Profiling: a comprehensive profile is compiled for each buyer based on various characteristics of their properties, including:
Year Built,
Zoning Code,
Property Use,
Property Type,
Assessor Sale Dates and Amounts,
Total Area of Structures,
Lot Size and Dimensions,
Last Sales Price,
Last Sales Date,
Room Counts and Features (e.g., fireplaces, pools), and/or
Estimated Current Market Value and its range.
This profiling helps in understanding the buyer's preferences and investment patterns.

Further, to assess buyers'experience and activity levels, a scoring system is implemented:

Each completed transaction can contribute for example 10 points to the buyer's score, with additional points awarded for cash transactions.

The 10-point scoring system is an exemplary framework used to evaluate buyers. In this system, a buyer's score is determined by their activity level and how likely they are to purchase a specific property that has been presented to them. Points are awarded based on the buyer's history of completed real estate transactions, which helps to assess their engagement and investment behavior.

This scoring mechanism helps identify experienced buyers, enabling informed marketing strategies and outreach efforts.

Further, Buyers'property purchase locations and patterns are tracked and analyzed. This includes:
Identifying whether buyers exhibit consistent behaviors, such as purchasing specific types of properties at regular intervals (e.g., every three months).

Analyzing price trends and timing of purchases to predict future buying behavior.

In an exemplary embodiment, the evaluation logic for builders focuses on the number of land purchases and the volume of properties built and sold within a fiscal year.

For Hedge Funds and Institutional Buyers, the entities are monitored for portfolio growth, particularly focusing on the number of additional properties acquired in a fiscal year. Tracking is linked back to their Unique Mailing Addresses or Unique Names to ensure accurate profiling and record-keeping. For instance, the Hedge fund may operate through a single holding company while making acquisitions through various entities, such as thirty trusts and ten LLCs, all linked to twenty office or mailing addresses it owns nationwide. These associated entities and addresses will be unified under the primary hedge fund name.

Once the data and logic for determining potential buyers are established, the online real estate transaction platform processes the input accordingly.

As depicted in FIG. 1, the first step of the online real estate transaction platform includes receiving an address or APN of the real estate property from the user, at step 102.

Subsequently, the platform processes the received information to identify and retrieve property characteristics associated with the received address, at step 104, from a database, including total property value, number of bedrooms, number of bathrooms, square footage of the house, and land size. In an embodiment, the database (which is a MangoDB or AWS) includes all the data such as buyer profile and property identifier including property characteristics and ownership details. The data may be stored in the database in steps including collecting data from a plurality of sources such as public records and historical sales data, performing cleaning of the collected data, manipulating the cleaned data, and also converting the cleaned data into a structured format compatible with the database, which involves parsing and standardizing over a plurality of columns of data point. Thereafter, compiling property identifiers and buyer profiles.

In an embodiment, the buyer profile is compiled in steps, including identifying a plurality of buyers using their Full Name (first name, middle name/initial, last name) OR Buyer Unique Company Name (unique LLC name, corporate name, or unique trust name) OR Buyer Unique Associated Mailing Address/Office Address. It is important to track unique buyer names because one buyer can have multiple mailing or office addresses. For example, “Kind Homes Inc.” may have 20 different mailing addresses, but it can be seen that Kind Homes has purchased 200 properties under its unique LLC name. There is only one Joshua Ryan Chan in the USA, and it can be seen that 50 different properties are purchased in his unique name. Further, it is important to track unique mailing addresses (or office addresses) because one buyer might own multiple LLCs and trusts. For instance, it may be find out that 300 properties were purchased all tied to one unique mailing address (e.g., “112 S Tryon St, Suite 809”), which has purchased 300 different properties under various names, but the mailing address remains the same.

This method of tracking is unique and protected, ensuring that no other company can replicate it. Therefore, it is required to monitor Unique Individual Names, Unique Company Names (LLCs, Inc., etc.), Unique Trust Names, and Unique Mailing Addresses, all associated with the purchase of multiple properties.

Further, identifying a plurality of buyers with a history of real estate transactions, and classifying the identified buyers into categories based on their purchasing behavior and investment strategies, the categories include buy and hold investors and fix and flip investors, builders/developers, commercial property buyers, and hedge fund/institutional buyers. The steps further include determining buyer profiles for each category by evaluating historical transaction data, including fix and flip purchasing history, cash purchasing history, frequency of property purchases within a specified period, ownership of a real estate portfolio comprising two or more properties not occupied by the buyer, the recent addition of at least one new property to their portfolio within the last 12 months. Further, the steps include comparing the historical purchase price of properties against their estimated Automated Valuation Model (AVM) values at the time of purchase, wherein a purchase made at 95 percent or below, for example at 80 percent or below the AVM value qualifies as an investor purchase. Further, the steps include assigning characteristics to each buyer profile based on property attributes, including but not limited to Year Built, Zoning Code, Property Use, Property Type, Last Sale Date, Lot Size, Bedrooms, Bathrooms, Building Area, and Market Valuation; and storing and updating the buyer profiles to enhance the matching accuracy for potential real estate transactions.

In an embodiment, the property identifier is compiled in steps, including extracting data attributes associated with a property, such as parcel number, full property address, geographic coordinates, legal description, owner details, ownership, and occupancy status, mailing address details, deed information, tax assessment and fiscal details, property construction and zoning information, sales history, building and lot characteristics, room and structural details, year built, environmental and market valuation codes and storing the extracted data attributes to compile the property identifier.

Subsequently, the similar properties are identified, at step 106, based on the property characteristics associated with the received address.

Subsequently, buyers are identified and categorized, at step 108. In an embodiment, the buyers are identified among real estate investors who have historically purchased identified similar properties and analyzing their behavior patterns including frequency of property purchases, average purchase prices, preferred property conditions, and annual deal volume and categorized into one of three groups including fix and flip, buy and hold and Builders/Developers based on buyer's behavior pattern.

Subsequently, a specified number of potential buyers are searched, at step 110, from the groups within a first predefined area. In an embodiment, the first predefined area includes a radius of 0.1 miles or less around the received property address. In case, the required number of potential buyers is not found in the first predefined area, the specified number of potential buyers is identified within an expanded predefined area greater than 01 miles radius.

Thereafter, a list of the potential buyers for the real estate property is compiled and displayed to the user, at step 112. It is important to note that most compatible list of the potential buyers is determined by inventive modeling system for specific property entered. In an embodiment, the list includes their potential names, potential email addresses, potential social media, potential mail address and potential phone numbers, and is displayed to the user to enable direct outreach to each of these potential buyers.

Thus, the present invention provides a novel solution for identifying potential buyers for an identified real estate property by utilizing the inventive modeling system. The present invention provides a technically advanced solution compared to currently known alternatives. Furthermore, this solution is technically superior to existing methods because it eliminates the need for third-party involvement and associated commission fees. Further, this approach minimizes or alternatively eliminates the marketing guesswork associated with selling a property. It is designed to provide a fast and methodical process for selling a property, thereby avoiding the complexities and delays often introduced by third-party intermediaries as well as the required real estate agent fees.

1. A method for identifying potential buyers for a real estate property comprising:
receiving an Address or APN of the real estate property from a user;
retrieving property characteristics associated with the received address and APN from a database, including the real estate property type comprising: single-family residence, townhome, duplex, multifamily unit, and/or land;
the attributes of the real estate property comprising: presence of a pool, basement, garage, or carport, and/or number of stories;
the real estate property style comprising: ranch, colonial, or bungalow;
the real estate property zoning comprising: year the real estate property was built, total value of the real estate property, number of bedrooms, number of bathrooms; and
square footage of the real estate property;
identifying properties based on the property characteristics associated with the received address or APN;
identifying buyers among real estate investors who have historically purchased identified properties and analyzing their existing real estate portfolio to determine their preferred buying criteria and behavior patterns that include frequency of property purchases, average purchase prices, preferred property conditions, annual deal volume, and categorizing the buyers into one of three groups including fix and flip, buy and hold and developers/builders based on buyer's behavior pattern;
searching for a specified number of potential buyers from the groups within a first predefined area, wherein the first predefined area includes a radius of 0.1 miles around the received property address; and
compiling a list of the potential buyers for the real estate property, wherein the list includes their potential names, potential email addresses, potential social media profiles, potential mail addresses, and potential phone numbers, and displaying the list to the user to enable direct outreach to each of these potential buyers.

2. The method of claim 1, wherein the database includes information comprising buyer profile and property identifier, including property characteristics and ownership details.

3. The method of claim 2, wherein the data is stored in the database in steps:
collecting data from a plurality of sources, including public records and historical sales data;
performing cleaning of collected data and converting the cleaned data into a structured format compatible with the database, which involves parsing and standardizing over a plurality of columns of data points; and
compiling property identifiers and buyer profiles.

4. The method of claim 3, wherein the buyer profile is compiled in steps, comprising:
identifying a plurality of buyers with a history of real estate transactions;
classifying the identified buyers based on their purchasing behavior and investment strategies, including:
buy and hold investors, who retain purchased properties over time;
fix and flip investors who buy, renovate, and/or sell properties within a predetermined timeframe;
builders or developers who acquire land or properties for development and sale;
commercial property buyers who invest primarily in commercial real estate; and
hedge fund or institutional buyers who hold a portfolio of 150 or more properties;
determining buyer profiles for each category by evaluating historical transaction data, including:
cash purchasing history;
frequency of property purchases within a specified period
ownership of a real estate portfolio comprising two or more properties not occupied by the buyer; and
recent addition of at least one new property to their portfolio within the last 12 months;
comparing historical purchase price of properties against their estimated Automated Valuation Model (AVM) values at the time of purchase, wherein a purchase made at 80% or below the AVM value qualifies as an investor purchase;
assigning characteristics to each buyer profile based on property attributes, including but not limited to year built, zoning code, property use, last sale date, lot size, building area, and market valuation; and
storing and updating the buyer profiles to enhance matching accuracy for potential real estate transactions.

5. The method of claim 3, wherein the property identifier is compiled in steps, comprising:
extracting data attributes associated with a property, including but not limited to parcel number, full property address, geographic coordinates, legal description, owner details, ownership and occupancy status, mailing address details, deed information, tax assessment and fiscal details, property construction and zoning information, sales history, building and lot characteristics, room and structural details, environmental and market valuation code known as AVMs; and
storing the extracted data attributes to compile the property identifier.

6. The method of claim 1, wherein filtering criteria include at least one of the property details, ownership history, and/or valuation data that is used for identifying the buyers.

7. The method of claim 1, wherein the buyers are scored based on transaction frequency and cash purchases.

8. The method of claim 1, wherein the potential buyers are searched by matching property characteristics with historical buyer preferences within the predefined area around the received property.

9. The method of claim 1, further comprising:
updating a buyer's information every 24 hours.

10. The method of claim 1, wherein a property is identified within a 0.1-mile radius purchased at 80% or below of a current AVM value.

11. The method of claim 1, wherein the specified number of potential buyers is identified within a second predefined area if required number of potential buyers is not found in the first predefined area.

12. The method of claim 1, wherein potential names, potential email addresses, potential social media profiles, potential mail addresses, and potential phone numbers are verified names, verified email addresses, social media profiles, and verified phone numbers.
